(19) United States
(12) Patent Application Publication
(10) Pub. No.: US 2013/0064545 A1
(43) Pub. Date: Mar. 14, 2013

(54) Point-to-Multipoint Simultaneous Optical Transmission System

(71) Applicant: Chen-Kuo Sun, Escondido, CA (US)

(72) Inventor: Chen-Kuo Sun, Escondido, CA (US)

(21) Appl. No.: 13/230,437

(22) Filed: Sep. 12, 2011

(51) Int. Cl. H04J 14/00

(52) U.S. Cl. 398/70

(57) ABSTRACT

A point-to-multipoint optical communication network includes a fiber optic cable, and a single photodiode for optical/electrical conversion at the upstream end of the cable. On the other hand, an “n” number of electrical/optical up-converters are connected between an “n” number of downstream points and the downstream end of the cable. Within this arrangement, radio frequency signals “fₙ” from respective “n” different downstream points are impressed onto respective wavelengths “λₙ”. The resultant optical signals “λₙ” can then be simultaneously transmitted upstream over the fiber optic cable, and passed through the photodiode for optical/electrical conversion and transmission to an upstream point, according to “fₙ”. For downstream communications, a single transmitter and a single wavelength λ can be used to transmit all fₙ signals.

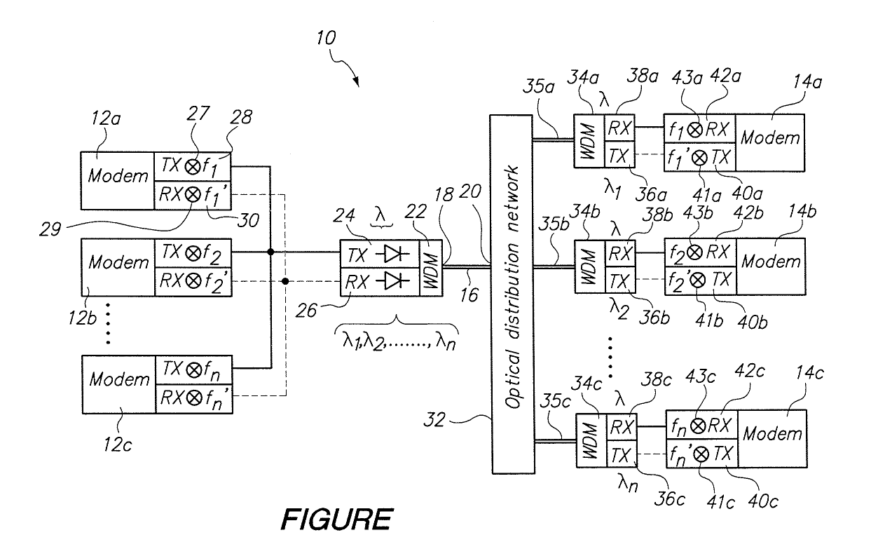

### FIELD OF THE INVENTION

The present invention pertains generally to optical communications systems and networks. More particularly, the present invention pertains to systems and networks that transmit radio frequency signals “f”, as optical signals “λ”, through optical fibers. The present invention is particularly, but not exclusively, useful as a point-to-multipoint network that effectively accommodates a plurality of signals within a confined bandwidth for simultaneous transmission on an essentially single wavelength, optical signal.

### BACKGROUND OF THE INVENTION

Many telecommunication networks typically function by transmitting signals that are carried on radio frequency (RF) waves. It is known, however, that such signals can also be optically transmitted over glass fibers. Consequently, depending on the particular application, and the economics that are involved, it may be desirable to incorporate an optical transmission capability within a communication network. When doing so, however, it is desirable to optimize the use of glass fibers or, stated differently, to use as few glass fibers as possible.

As a general consideration, in order to incorporate an optical communication capability into a communication network, it is first necessary to up-convert signals from a radio frequency carrier “f” to an optical wavelength “λ”. Next, it is necessary to introduce the optical signal into the upstream end of an optical fiber cable. The optical signal is then transmitted over the cable. At the downstream end of the cable, it is necessary to down-convert the signal from its optical wavelength “λ” back to the original radio frequency signal “f”. In general, this works fine for point-to-point communications (i.e. direct communication from one point to another point). It can become problematical, however, when more than two points at the same end of the optical cable are involved at the same time.

One solution for using a single optical fiber in a network, for the purpose of communicating between a single upstream point [modem], and numerous downstream points [modems], has been to employ a transmission protocol. Normally, such a protocol allows the different points to queue in a manner that gives them sequential access to the optical fiber. This obviously has its limitations, as queuing often delays transmissions. An option here is to incorporate more and different fiber optic cables. This, however, can be costly.

In light of the above, it is an object of the present invention to provide a point-to-multipoint optical communications network that allows a plurality of downstream points to simultaneously transmit optical signals to a single upstream point using a same confined bandwidth, on a same optical fiber. Another object of the present invention is to provide a system and method for simultaneously receiving a plurality of optical signals over a single optical fiber at a same point. Yet another object of the present invention is to provide a point-to-multipoint optical communications network that is easy to use, is simple to implement, and is comparatively cost effective.

### SUMMARY OF THE INVENTION

A system for simultaneously transmitting a plurality of optical signals over a single optical fiber cable between a single upstream point and an “n” number of downstream points is provided. In particular, the present invention envisions there will be a single point connected to the upstream end of the optical fiber, and there will be an “n” number of points that are connected to a respective “n” number of downstream ends of the optical fiber. Typically, “n” will be an integer in the range from 1 to 10.

An “n” number of up-converters are required for use at the downstream end of the optical fiber cable. Specifically, each of these up-converters is connected to a downstream end of the optical fiber between the optical fiber and a respective downstream point. The purpose of these up-converters is to impress a radio frequency signal “fₙ” from the particular downstream point onto an optical signal of wavelength “λₙ”. The optical signal “λₙ” will then be transmitted over the optical fiber cable.

For the present invention, the radio frequency that is used for the signal “fₙ” at each particular downstream point [modem] will be specific for the particular point. Further, the difference between frequencies (Δf), where fₙ=f₍ₙ₋₁₎+Δfₙ, may either be the same, or it may vary to make it unique. Typically, each Δf will be in a range between 50 MHz and 1 GHz. With this in mind, each radio frequency fₙ is up-converted to a respective optical signal λₙ. Along with the frequency differences for fₙ, the optical signals λₙ will also differ. Specifically, λₙ=λ₍ₙ₋₁₎+Δλₙ. In this relationship, the difference in wavelength (Δλ) between an optical signal λₙ and λ₍ₙ₊₁₎ may either be the same, or it may vary to make it unique. Typically, each Δλ will be greater than approximately 0.5 nm. Despite their differences, all of the optical signals λₙ that are to be simultaneously transmitted upstream through the optical fiber will be within a relatively narrow bandwidth that extends between λ_{Lo} and λ_{Hi} (λ_{Lo}<λₙ<λ_{Hi}).

As indicated above, there are an “n” number of downstream points individually connected to the “n” number of downstream ends of the optical fiber. Although there is only one upstream point, there may be a plurality of modems. Consequently, it is necessary there be only one receiver with only a single photodiode connected to the upstream end of the optical fiber. Importantly, the photodiode at the upstream point needs to accommodate the narrow bandwidth between λ_{Lo} and λ_{Hi} (λ_{Lo}<λₙ<λ_{Hi}). For example, if n=10 and Δλ=0.5 nm, the photodiode will need to accommodate a 5 nm bandwidth. It will then be able to simultaneously receive all signals transmitted on wavelengths λₙ from the various “n” downstream points.

A plurality of RF down-converters are connected to the photodiode at the single upstream end of the optical fiber. Specifically, these down-converters are provided to convert the respective optical signal “λₙ” to their respective radio frequency signals “fₙ”, and to segregate the signals “fₙ” from each other for use at the upstream point, according to frequency.

In order to provide for downstream communications over the network, a single downstream transmitter is connected to the upstream end of the optical fiber. Thus, signals “fₙ” from the upstream point(s) are transmitted to the plurality of downstream points on a single optical signal of wavelength λ. The signals “fₙ” are then routed at the downstream end for further transmission to the particular downstream points. As an added feature, each modem at the upstream point and each downstream point may separately include a tuner for selectively receiving the radio frequency signal “fₙ” addressed to the particular downstream point.

### BRIEF DESCRIPTION OF THE DRAWINGS

The novel features of this invention, as well as the invention itself, both as to its structure and its operation, will be best understood from the accompanying drawing, taken in conjunction with the accompanying description, in which similar reference characters refer to similar parts, and in which the FIGURE is a schematic presentation of the components required for a system in accordance with the present invention.

### DESCRIPTION OF THE PREFERRED EMBODIMENTS

Referring to the FIGURE, a point-to-multipoint network in accordance with the present invention is shown schematically and is designated 10. As shown, the network 10 includes an “n” number of upstream modems 12, and a same “n” number of downstream points [modems] 14, of which the modems 12a, 12b, 12c, 14a, 14b and 14c are exemplary. For the present invention, the number “n” may vary, but it is anticipated to typically be an integer in the range from two to ten. Thus, the upstream modem 12c and the downstream modem 14c each sequentially represent the possibility for a respective third through tenth modem.

As shown in the FIGURE, the network 10 includes an optical fiber 16 having an upstream end 18 and a downstream end 20. Further, a wavelength-division multiplexer (WDM) 22 of a type well known in the pertinent art is shown connected to the optical fiber 16 at its upstream end 18. Along with the WDM 22, there is a transmit, electrical/optical up-converter 24 that includes a laser diode. And, there is a receive, optical/electrical down-converter 26 that includes a photodiode. Using the upstream modem 12a as an example, it will be seen that a radio frequency (RF) up-converter 27 and a transmitter 28 are connected with the modem 12a. Specifically, within this combination, when a signal leaves the modem 12a for transmission over the network 10, it leaves as an RF signal with a frequency “fₙ”. Thus, in the specific case of modem 12a, this signal will be passed from the modem 12a to the electrical/optical up-converter 24 as a downstream signal with the frequency “f₁” (i.e. n=1). Still referring to the upstream modem 12a, it will be seen that this modem 12a also includes an RF down-converter 29 and a receiver 30 that are connected with the optical/electrical down-converter 26. Specifically, within this combination, the modem 12a is set to receive an upstream signal from the optical/electrical down-converter 26 that has an RF frequency “f₁”. Recall from above, the modem 12a is only exemplary. As intended for the present invention, the modems 12ₙ will all function substantially the same, and each will individually interact directly with the electrical/optical up-converter 24 and the optical/electrical down-converter 26. The only difference here will be that each modem 12ₙ will be using a different respective frequency “fₙ”.

At its downstream end 20, the optical fiber 16 is connected with an optical distribution network 32 that, in turn, is separately connected to the various downstream points [modems] 14a-c. More specifically, the optical distribution network 32 is directly connected to WDMs 34a, 34b and 34c via respective optical fibers 35a, 35b and 35c. Further, each of the WDMs 34a, 34b and 34c is connected to a respective electrical/optical up-converter 36a, 36b and 36c, as well as a respective optical/electrical down-converter 38a, 38b and 38c. In turn, each of the electrical/optical up-converters 36a, 36b and 36c is respectively connected to a transmitter 40a, 40b and 40c with a respective RF up-converter 41a, 41b and 41c. And, each of the optical/electrical down-converters 38a, 38b and 38c is respectively connected to a receiver 42a, 42b and 42c with a respective RF down-converter 43a, 43b and 43c.

An important aspect of the present invention concerns the down-converter 26 and its photodiode that are connected with the upstream end 18 of the optical fiber 16. Specifically, this single photodiode (i.e. optical/electrical down-converter 26) is selected to simultaneously accommodate several optical wavelengths (λ) that are within a relatively narrow bandwidth. Preferably, this narrow bandwidth will be between a wavelength λ_{LO} and a wavelength λ_{HI}, and will be approximately 5 nm.

In an operation of the present invention, all of the downstream points [modems] 14a-c are able to simultaneously transmit to a respective upstream modem 12a-c over the optical fiber 16. By way of example, the modem 14c is chosen for disclosure here as it is considered to be representative of all downstream points [modems] 14. Accordingly, the designation “n” may be any number, and it is used to apply to a particular downstream point 14. With this in mind, consider a radio frequency (RF) signal “fₙ” that is created at the modem 14c. Once created, the signal “fₙ” is sent by the transmitter 40c to the electrical/optical up-converter 36c where it is converted from the RF signal “fₙ” into an optical signal “λₙ”. WDM 34c then passes the optical signal “λₙ” to the optical distribution network 32 for direct transmission over the optical fiber 16, without delay. Along with this transmission of the optical signal “λₙ”, also consider the possibility of a radio frequency (RF) signal “f₂” being simultaneously created at the modem 14b. In this case, the signal “f₂” is sent by the transmitter 40b to the electrical/optical up-converter 36b, where it is converted from the RF signal “f₂” into an optical signal “λ₂”. WDM 34b then passes the optical signal “λ₂” via the optical fiber 35b to the optical distribution network 32 for direct transmission over the optical fiber 16, together with any other optical signal “λₙ”.

In the above example, the RF signal “fₙ” (e.g. f₃) will be different from the signal “f₂”. Specifically, as envisioned for the present invention, the difference between one radio frequency “fₙ” and any other radio frequency in the system (i.e. Δf=f₍ₙ₊₁₎−fₙ) will be approximately 100 MHz. In a similar manner, there will also be a difference between one optical signal and another (Δλ). In this case a relationship is envisioned wherein λₙ=λₙ₋₁+Δλₙ, with each Δλ being predetermined. Specifically, each wavelength difference Δλ may be unique or it may be relatively constant. In any event, each Δλ is preferably greater than approximately 0.5 nm. Importantly, in each instance, the resultant λₙ will be within the bandwidth between λ_{LO} and λ_{HI} that is established by the photodiode of optical/electrical down-converter 26.

At the upstream end 18 of optical fiber 16, as the optical signals λₙ (e.g. λ₂ and λ₃) are received at WDM 22 they are sent to the down-converter 26 where they are converted back to their original radio frequency “fₙ”. The radio frequency signals “fₙ” are then sent, according to their RF frequency, to the appropriate receiver 30 of upstream point [modem] 12 where they are processed.

For a downstream transmission of signals from the upstream point [modem] 12 to the corresponding downstream point [modems] 14, the nature of the single upstream point 12 allows for the more traditional communication arrangement. In particular, only one electric/optical up-converter 24 is needed, and all of the radio frequency signals “fₙ” can be converted onto a same optical signal wavelength “λ”. This optical signal “λ” is then sent over the optical fiber 16, and is routed by the optical distribution network 32 to a particular downstream point [modem] 14, according to the frequency “fₙ”. Thus, at the optical/electrical down-converter 38a, radio frequency signal f₁ will be routed to downstream point 14a. Similarly, radio frequency signal fₙ will be routed to downstream point 14c.

While the particular Point-to-Multipoint Simultaneous Optical Transmission System as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A system for simultaneously transmitting signals between a single upstream point and a plurality of downstream points, wherein the downstream points are individually numbered from “1” to “n”, and the system comprises:
an optical fiber having an upstream end and a plurality of downstream ends;
a plurality of up-converters, wherein each up-converter is connected to a respective downstream end of the optical fiber at a respective downstream point for impressing a radio frequency signal “fₙ” from the respective downstream point onto a respective optical signal of wavelength “λₙ” for a simultaneous upstream transmission of signals “fₙ” from different downstream points “n” over the optical fiber to the single upstream point;
a single photodiode connected to the upstream end of the optical fiber for simultaneously receiving transmitted signals with wavelengths λₙ from the downstream points; and
a down-converter connected to the photodiode at the single upstream point for converting the radio frequency signals “fₙ” from the respective wavelengths “λₙ” for use at the upstream point.

2. A system as recited in claim 1 wherein the single photodiode has a receive bandwidth and the wavelengths “λₙ” are individually and collectively within the receive bandwidth of the single photodiode.

3. A system as recited in claim 1 further comprising a plurality of down-converters connected to the photodiode at the single upstream point, for segregating the signals “fₙ” from each other, according to frequency.

4. A system as recited in claim 1 further comprising a downstream transmitter connected to the upstream end of the optical fiber for sending signals “fₙ” from the single upstream point to the plurality of downstream points on a single optical signal of wavelength λ, wherein the signals “fₙ” are routed at the downstream end for further transmission to the particular downstream points.

5. A system as recited in claim 4 further comprising a tuner at each downstream point for selectively receiving the radio frequency signal “fₙ” addressed to the particular downstream point.

6. A system as recited in claim 1 wherein λₙ=λ+Δλₙ, and wherein each Δλ is unique.

7. A system as recited in claim 1 wherein λₙ=λ+Δλₙ, and wherein each Δλ is equal to approximately 0.5 nm.

8. A system as recited in claim 1 wherein f₍ₙ₊₁₎−fₙ is equal to approximately 100 MHz.

9. A system as recited in claim 1 wherein n is an integer in a range from 1 to 10.

10. A receiver for simultaneously receiving signals at a single upstream point from a plurality of downstream points over an optical network having a single optical transmission fiber with an upstream end and a plurality of downstream ends, the receiver comprising:
a single photodiode for receiving light in a bandwidth between a wavelength λ_{Lo} and a wavelength λ_{Hi}, wherein the photodiode is connected to the upstream end of the optical fiber for simultaneously receiving optical signals λₙ through the optical fiber from an “n” number of different downstream points, wherein the wavelength λₙ is within the bandwidth from λ_{Lo} to λ_{Hi} (λ_{Lo}<λₙ<λ_{Hi}); and
a plurality of down-converters connected to the photodiode for converting each λₙ to a respective radio frequency signal fₙ, and for segregating the signals fₙ according to frequency at the single upstream point.

11. A receiver as recited in claim 10 wherein the network further comprises an “n” number of up-converters, and wherein each up-converter is connected to a respective downstream end of the optical fiber at a respective downstream point for impressing a radio frequency signal “fₙ” from the respective downstream points onto a respective optical signal of wavelength “λₙ” for a simultaneous upstream transmission of signals “fₙ” from the different downstream points “n” over the optical fiber to the single upstream point.

12. A receiver as recited in claim 10 wherein the network further comprises a downstream transmitter connected to the upstream end of the optical fiber for sending signals “fₙ” from the single upstream point to the “n” number of downstream points on a single optical signal of wavelength λ, wherein the signals “fₙ” are routed at the downstream end for further transmission to the particular downstream points.

13. A receiver as recited in claim 10 wherein the network further comprises a tuner at each downstream point for selectively receiving the radio frequency signal “fₙ” addressed to the particular downstream point.

14. A receiver as recited in claim 10 wherein λₙ=λ+Δλₙ, and wherein each Δλ is unique.

15. A receiver as recited in claim 10 wherein λₙ=λ+Δλₙ, and wherein each Δλ is equal to approximately 0.5 nm.

16. A receiver as recited in claim 10 wherein λₙ=λ+Δλₙ, and wherein each Δλ is established to avoid overlaps between any two different λₙ and a consequent beating of the respective signals.

17. A receiver as recited in claim 10 wherein f₍ₙ₊₁₎−fₙ is equal to approximately 100 MHz.

18. A method for simultaneously transmitting signals between a single upstream point and a plurality of downstream points, wherein the downstream points are individually numbered from “1” to “n”, and the method comprises the steps of:
providing an optical fiber having an upstream end and a plurality of downstream ends;
connecting each of a plurality of up-converters to a respective downstream end of the optical fiber, wherein each up-converter is connected at a different downstream point;
impressing a unique radio frequency signal “fₙ” at each different downstream point “n” onto an optical signal of respective wavelength “λₙ” for a simultaneous upstream transmission of the signals “fₙ” from the different downstream points “n” over the optical fiber to the single upstream point;
engaging a single photodiode with the upstream end of the optical fiber, wherein the single photodiode has a receive bandwidth between λ_{Lo} and λ_{Hi}, and wherein the wavelengths “λₙ” received by the photodiode are individually and collectively within the receive bandwidth of the photodiode (λ_{Lo}<λₙ<λ_{Hi});
using a plurality of down-converters connected to the photodiode for converting each λₙ to a radio frequency signal f′ₙ, and for tuning the signals f′ₙ according to frequency;
employing a downstream transmitter connected to the upstream end of the optical fiber for a downstream transmission of signals “fₙ” from the single upstream point to the plurality of downstream points on a single optical signal of wavelength λ;
routing signals “fₙ” at the downstream end for further transmission to designated downstream points; and
tuning the signals “fₙ” at each designated downstream point for receipt of the signal.

19. A method as recited in claim 18 wherein λₙ=λ+Δλₙ, and wherein each Δλ is unique.

20. A method as recited in claim 19 wherein each Δλ is established to avoid overlaps between any two different λₙ and a consequent beating of the respective signals.
